(19) United States
(12) Patent Application Publication
(10) Pub. No.: US 2005/0212967 A1
(43) Pub. Date: Sep. 29, 2005

(54) System for displaying a sequence of moving images

(75) Inventor: Nicolas Quesne, Eybens (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 11/086,808

(22) Filed: Mar. 22, 2005

(30) Foreign Application Priority Data
Mar. 23, 2004 (FR) 04 02991

(51) Int. Cl. H04N 5/44

(52) U.S. Cl. 348/559

(57) ABSTRACT

In order to display moving images, an input receives a video signal transporting video images. A user interface receives commands input by a user. An input video subsystem continuously generates a first stream of video images on the basis of the input video signal. At least one volatile storage unit stores a sequence of images extracted from the first stream of images, either continuously, or in response to a “record” command given by the user. An output video subsystem generates and displays a second stream of images on the basis selectively of: the first stream of video images, the stored sequence of images, or a combination of the two, in response to an appropriate read command input by the user via the user interface.

### PRIORITY CLAIM

This application claims priority from French Application for Patent No. 04 02991 filed Mar. 23, 2004, the disclosure of which is hereby incorporated by reference.

### BACKGROUND OF THE INVENTION

1. Technical Field of the Invention

The present invention relates in a general manner to systems for displaying a sequence of moving images. It finds its application most particularly in the field of television receivers.

2. Description of Related Art

Recent television sets possess a function making it possible to freeze an image (freeze function) of the video signal, that is to say to display it in a continuous loop on the screen. This function is useful for example for allowing the user to note down an address or a telephone number, or sports results. However, it leads to a temporary loss of the program currently being broadcast. It further requires an internal storage capacity for the corresponding image.

It is also known to produce a display of several images of reduced size (“multipix”) by producing, for example, a matrix of 3×3 or 3×4 small stationary images. These small images are produced by selecting and storing a series of images at a frequency below the scanning frequency of the display screen. This function is most relevant when the user wishes to have an overview of the programs for several stations, thanks to the sampling of channels, without however resorting to multiple tuners. A set of channels must then be scanned, and the image of a particular channel can be refreshed only after a relatively long time interval, which is dependent on the number of channels scanned and on the speed of the channel scanning system. The sequences thus obtained for each channel are then very “jerky”. Moreover, the images are lost once they have been viewed and do not make it possible to return to a sequence considered a posteriori to be relevant.

However, it may be relevant for a user to be able to display again (“replay”) a sequence of a program deemed to be relevant a posteriori (that is to say after viewing it as a sequence of the program currently being broadcast), such as, for example, a goal or point scored during a sporting event.

The relevance of a sequence may also be perceived in advance by the user, such as, for example, a golfer's swing. The user may wish to repeat the displaying of the sequence for a better appreciation of the golfer's technique.

In both cases, it is desirable to allow him to record a sequence on demand.

The recording of programs is made possible, at present, by equipment complementary to the television set, of video recorder type, “set-top box” type with VCR (Video Cassette Recorder) function, that is to say the recording on hard disk, and soon DVD (Digital Versatile Disc) reader/writer type. This equipment is satisfactory for producing a durable recording, i.e., one which is non-volatile, of a program lasting a long time (several hours). Nevertheless, they are expensive, require the manipulation of a mass storage medium, and their deployment for the recording of a sequence cannot be done with the speed required in the aforesaid exemplary applications. Furthermore, the non-volatile recording that they afford is generally unnecessary for the aforesaid exemplary uses.

There is accordingly a need to allow a user to record a sequence of a program that he wishes to view again at a later time, but before switching off his television set.

### SUMMARY OF THE INVENTION

For this purpose, an embodiment of the invention proposes a system for displaying moving images, comprising:
an input for receiving a video signal transporting video images;
a user interface for receiving commands input by a user;
an input video subsystem for continuously generating a first stream of video images, on the basis of the input video signal;
at least one volatile storage unit for storing a sequence of images from the first stream of images, either continuously with a “refresh” mechanism until the receipt of a “save” command input by the user via the user interface, or in response to a “record” command input by the user via the user interface; and
an output video subsystem for generating and displaying a second stream of images, on the basis selectively of the first stream of video images, of the stored sequence of images, or of a combination of the two, in response to an appropriate read command input by the user via the user interface.

Such a system can easily, and at low cost, be integrated into a conventional television set.

Thus the user can view a relevant sequence of images again through actuation via the user interface, without however calling upon a complex external system of the hard disk or video hardware type.

In one embodiment, the output subsystem is devised so as, in response to respective commands input by the user via the command interface, to display again the stored sequence of images according to an advanced mode of display, comprising forward or backward slow-motion display, forward or backward accelerated display, frame-by-frame display, freeze frame, and zoom.

The user is then free to analyze the relevant sequence and to concentrate on a particular aspect such as the technique of the golfer, the collective action of the football team, etc.

In another embodiment, the input subsystem furthermore comprises a module for vertical and/or horizontal decimation, so as to produce the images of the sequence of images stored by decimating the images of the first stream of images. The vertical and/or horizontal decimation factors of the decimation module can in particular be selected by the user via the user interface.

By virtue of such a decimation module, the stored image sequences may be longer, for given storage capacity, than with images stored in non-decimated form. The user can even envisage storing several sequences in a row so as to re-broadcast them at his leisure at the end of the game, for example.

In accordance with another embodiment, a system, comprises an input video subsystem operable to receive a first video signal corresponding to a program currently being viewed by a user, the input video subsystem outputting a second video signal based on the first video signal and further outputting a sequence of images taken from the first video signal. A memory stores the sequence of images. An output video subsystem is operable to receive the second video signal and access the memory to retrieve the sequence of images, the output video subsystem outputting a third video signal which combines the second video signal and the retrieved sequence of images for simultaneous viewing by the user.

In accordance with another embodiment, a system for displaying moving images comprises an input for receiving a video signal transporting video images and an input video subsystem for continuously generating a first stream of images on the basis of the input video signal. A memory stores a sequence of images extracted from the first stream of images. An output video subsystem generates and displays a second stream of images which comprise a selected one of: the first stream of video images, the stored sequence of images, or a combination of the first stream of video images and the stored sequence of images.

### BRIEF DESCRIPTION OF THE DRAWINGS

Other characteristics and advantages of the invention will become further apparent on reading the description which follows. The latter is purely illustrative and should be read in conjunction with the appended drawings, in which:

FIG. 1 illustrates, in block diagram form, the principle of a system according to an embodiment of the invention;

FIG. 2 illustrates the recording loops of the volatile storage unit used in an embodiment of a system according to the invention;

FIG. 3 illustrates an exemplary embodiment of a system according to the invention; and

FIG. 4 illustrates an exemplary viewing in inset mode of an image sequence generated by a system according to the invention.

### DETAILED DESCRIPTION OF THE DRAWINGS

The principle of an embodiment of the system according to the invention is represented in FIG. 1 in block diagram form.

A microprocessor 60 provides for the management of the system according to the invention in response to commands input by the user via the user interface 50 (or MMI, standing for “Man-Machine Interface”).

A video signal D1 is received on the input 10 of an input video subsystem SSVint of the system. This signal, which corresponds to the program currently being viewed by the user, can be, for example, a digital video signal emanating from a multistandard digital video decoder, allowing the conversion of an analog television signal (NTSC, PAL, SECAM) into a digital signal. The signal may also emanate from a digital signal received by satellite, by cable or from an MPEG decoder (DVD). Each image is typically formed of two frames or half images A and B received successively, and which correspond respectively to the even lines and odd lines of a video image. Their union makes it possible to reconstitute an image comprising the whole set of lines. In the subsequent account, the term “image” will be used simply to refer to these fields A and B.

The subsystem SSVin continuously generates a first stream VIDEO_1 of video images on the basis of the input video signal D1 and transmits it to an output video subsystem SSVout via a link 40.

In a manner known per se, a volatile memory (RAM, standing for “Random Access Memory”) 45, for example a memory of SDRAM (standing for Synchronous Dynamic RAM) or DDR (standing for Double Data Rate) type, is provided for the temporary (volatile) storage of the images used for the upconversion of the image flow. This conversion is performed by interpolating additional images to be inserted into the stream of images VIDEO_1. It proves to be necessary when the input signal is, for example, a 50 Hz signal of the video or movie type which must be converted into a 100 Hz signal for television sets having this display frequency, or else a 60 Hz signal of the video or movie type (3:2 or 2:2) to be converted into a 120 Hz signal. This conversion is also implemented when the frequency of the signal is retained (60 Hz to 60 Hz progressive, for example) but when specific filters are applied to the images to eliminate glitches and compensate for losses of resolution. It will be noted that the invention applies also when the output signal is intended for a screen of LCD (VGA, SVGA, etc.) type. According to the type of conversion, the number of frames A and B to be stored is bigger or smaller. The frames A and B necessary for the conversion are extracted from the stream of video images VIDEO_1 at the level of the subsystem SSVin, and are stored in the memory 45 via a link 21. The upconversion is carried out by a conversion device (not represented in FIG. 1) of the subsystem SSVout. This device combines the stream of video images VIDEO_1 emanating directly from the subsystem SSVin with the necessary fields A and B, which are read from the memory 45 via a link 22. For this purpose, the conversion device has read and write access to the memory 45.

It will be noted that the input video subsystem SSVin can also comprise a first decimator 20 making it possible to carry out a vertical and/or horizontal decimation of the images of the stream VIDEO_1 of video images for the functions of enhanced display of the display system. Thus, the pixels of decimated lines and/or columns of the images are not recorded in the memory 45. These functionalities may be triggered by the user by inputting appropriate commands via the user interface 50.

Here, the volatile memory 45 fulfils a second function of storing images, namely the images corresponding to a sequence of images VIDEO_seq that the user wishes to be able to view again at a later time, but even so before switching off his television set.

For the recording of such a sequence, the user can input a record command via the user interface 50. The microprocessor 60 transmits this command to the subsystem SSVin, leading to the copying of the subsequent images to the volatile memory via the link 31. This recording is completed, for example, when an end of recording command is received via the user interface 50, and at the very latest when the maximum storage capacity of the volatile memory dedicated to this function is reached.

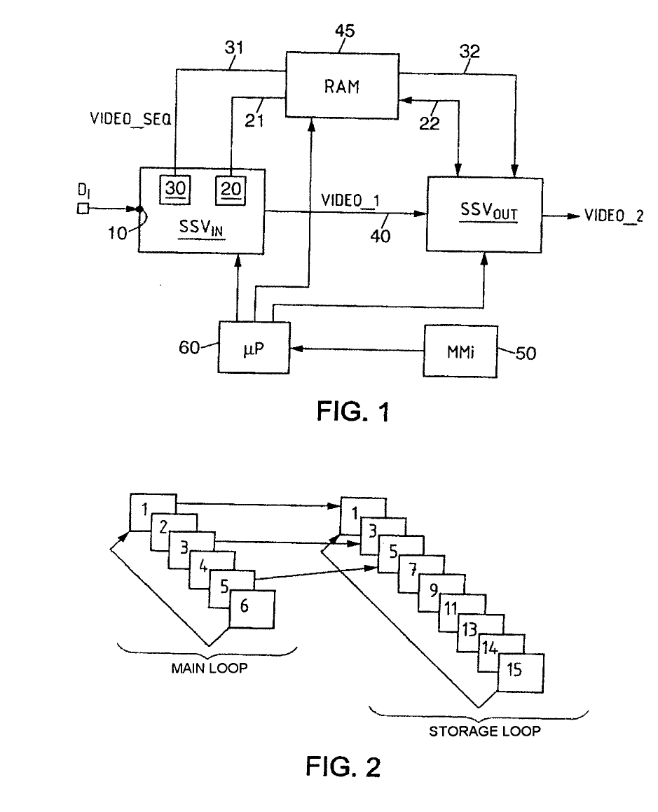

As a variant, the user can, still via the user interface 50, activate the automatic and continuous storage of the images of the stream of video images VIDEO_1. Considering the limited storage capacity of the memory 45, there is provided a mechanism for refreshing the content of the volatile memory, as described later in conjunction with the diagram of FIG. 2. A save command input by the user via the user interface 50 stops the recording of new images, so as to allow the replaying of the sequence formed of the images stored hitherto. This command may be identical to the end of recording command mentioned above. The microprocessor 60, as indicated previously, provides for the management of the system in response to the commands input by the user.

When the user inputs a command to replay the sequence VIDEO_seq formed from the latest images stored, the images are sent to the subsystem SSVout by way of the link 32 (FIG. 1).

The subsystem SSVout allows the upconversion, when it is necessary, of the stream VIDEO_1 of video images thanks to the frames A and B stored for this purpose in the volatile memory 45. The result of this conversion is another stream of video images VIDEO_2, corresponding to the converted stream of video images VIDEO_1.

The subsystem SSVout can also produce the stream of video images VIDEO_2 uniquely on the basis of the sequence VIDEO_seq of images stored in the volatile memory 45, and received via the link 32. If the nature of the input video signal requires an upconversion, the sequence of images stored in the volatile memory 45 is processed in the same manner before it is dispatched to an image composition module (not represented in FIG. 1) of the subsystem SSVout.

The output subsystem SSVout also allows a combination of the above two possibilities, as a function of the commands input via the user interface, so as to obtain on the screen a composition of the images emanating directly from the stream VIDEO_1 of video images (the program currently being broadcast) and the sequence of recorded images VIDEO_seq. The sequence of images stored may, for example, be superimposed on the images of the stream VIDEO_1 in a window of reduced size, according to a mode of display by inset known per se. The superimposing may be inverse. An example of such inset is commented on subsequently. The images of the sequence VIDEO_seq and of the stream VIDEO_1 can also be of identical size while being displayed according to a mosaic display mode.

In one embodiment, a second decimator 30 can also be provided so as to allow the storage of a longer sequence of images, but of reduced quality. As a function of the commands input by the user through the user interface 50, the microprocessor 60 can activate the decimator 30 so as to effect on the images intended to be stored in the volatile memory a decimation which may be vertical, horizontal and/or temporal. The video output subsystem SSVout then takes account of the decimation factors so as to correct the images of the sequence as a function of the display format selected.

Table 1 hereinbelow gives examples of duration (in seconds) of sequences that can be stored in an SDRAM memory of 32 Mbytes for an input video signal of 50 Hz (20 ms between each frame A and B) for various combined decimations. For this example, the size of a frame A or B is 0.420 Mbytes in these examples. The durations are given for the cases without horizontal or vertical decimation, with horizontal decimation of 1:2 type, with horizontal and vertical decimation of 1:2 type, and furthermore as a function of the temporal decimation which may be: none, 1:2, 1:4, 1:6 or 1:8. The durations are calculated by deducing from the available memory size (32 Mbytes) the memory space taken by the Teletext data Txt and the application programs (that are loaded into the SDRAM memory during the operation of the television set of the example chosen).

TABLE 1

| | | Duration (in seconds) of the | | | | |
|---|---|---|---|---|---|---|
| | | sequence recorded | | | | |
| | number | no | | | | |
| | of | temporal | | | | |
| SDRAM | frames | deci- | 1 image | 1 image | 1 image | 1 image |
| 32 Mbytes | stored | mation | out of 2 | out of 4 | out of 6 | out of 8 |
| no | 52 | 1.04 | 2.08 | 4.16 | 6.34 | 8.32 |
| decimation | | | | | | |
| horizontal | 104 | 2.08 | 4.16 | 8.32 | 12.48 | 16.64 |
| decimation | | | | | | |
| by 2 | | | | | | |
| horizontal | 208 | 4.16 | 8.32 | 16.64 | 24.96 | 33.28 |
| and | | | | | | |
| vertical | | | | | | |
| decimation | | | | | | |
| by 2 | | | | | | |

FIG. 2 illustrates the two types of storage of images in the memory 45 of FIG. 1. In the case of an upconversion of the input video signal, a certain number of frames A and B is required by the output video subsystem SSVout for the interpolation of the additional images as seen above. An example with six frames A and B, numbered from 1 to 6 and corresponding to three complete images, is presented in the left part of FIG. 2. The number of frames thus stored may reach ten in the case of a conversion of the 3:2 type (so-called “three to two”) of a 60 Hz video signal. These frames form a first loop, the so-called main loop, which is automatically refreshed over time so that the frames A and B which are necessary for the interpolation of the additional images of the stream VIDEO_2 are permanently available.

The second loop, the so-called storage loop, corresponds to the sequence VIDEO_seq of the images stored with refreshing to allow the replaying of the sequence. In the example represented in the right part of FIG. 2, the size of the volatile memory is such that only 9 frames are stored at maximum. The decimation illustrated in this example is a temporal only decimation: only one frame out of two is stored. The frames stored correspond in the example to the frames of type A or B only which are numbered from 1 to 15. Some of these frames are identical to the frames of the main loop. In the example of FIG. 2, the three frames A of the main loop, numbered 1, 3 and 5, are identical to the first three frames of the storage loop. The storage loop is also refreshed as soon as the maximum number of images that can be stored is reached. As the sequence of stored images VIDEO_seq contains only frames corresponding to even lines, an interpolation of the missing lines is performed for each frame at the level of the output subsystem SSVout during the production of the stream of video images VIDEO_2.

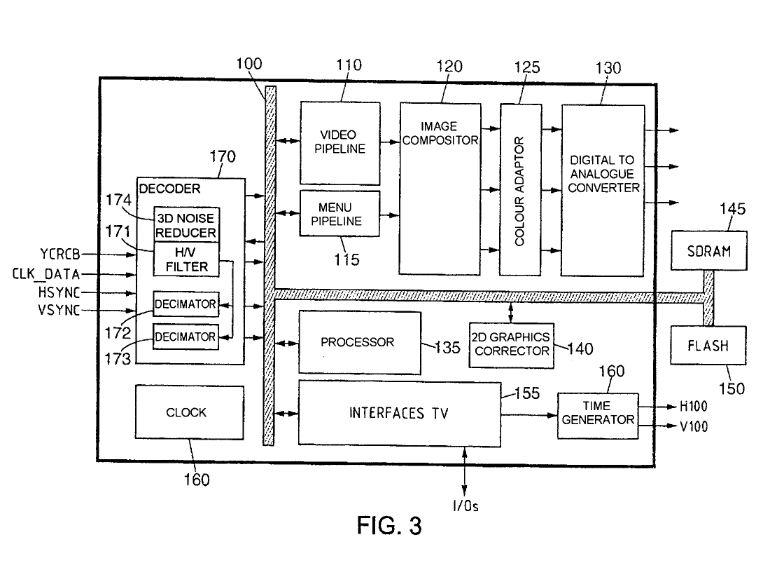

FIG. 3 shows an exemplary embodiment of the system according to the invention. Here this is an integrated circuit which is intended for a 100 Hz television set to simplify our account, and which utilizes the STV3500 circuit marketed by STMicroelectronics. This system could also be adapted to a so-called “double scan” or “multiscan” television set. Matrix panels such as an LCD or plasma television set are also conceivable.

A bus 100 makes it possible to link the various components of the circuit. A decoder 170 receives a clock signal CLK_DATA, vertical synchronization VSYNC and horizontal synchronization HSYNC signals, and a digital video signal in the YCrCb standard coding format. The decoder 170, which corresponds to the video subsystem SSVin of FIG. 1, comprises a horizontal and vertical filter 171 which makes it possible to prevent aliasing effects. The decoder also comprises a noise reducing additional filter 174 allowing spatial and temporal filtering of intraband noise. Finally, two decimators 172 and 173 enable the decoder 170 to reduce the size of the images of the input video signal. The first decimator 172 is intended for the functions of advanced display and corresponds to the decimator 20 of FIG. 1. The second decimator 173 corresponds to the decimator 30 of FIG. 1 and makes it possible to increase the storage capacity in the volatile memory 145, for example of SDRAM type, which corresponds to the memory 45 of FIG. 1. The images thus generated are sent via the bus 100 to the memory 145. The decoder also sends frames A and B to the memory 145 for the upconversion carried out at the level of the video pipeline 110.

A clock 160 makes it possible to generate the various asynchronous clock signals necessary for the various devices represented in FIG. 3.

A video pipeline 110 carries out the upconversion on the basis of the image stream received from the decoder 170, and fields A and B are stored for this purpose in the memory 145. This pipeline 110 belongs to the subsystem SSVout of FIG. 1. The video pipeline 110 also comprises modules making it possible to improve the video signal emanating from the upconversion. The image stream VIDEO_2, which corresponds either to the program currently in progress, or to the sequence of stored images VIDEO_seq, or else to a combination of the two according to a mode of display by inset, is composed directly in the memory 145 so as to produce a single stream of images.

A pipeline managing the display on the screen, called the menu pipeline 115 is also provided so as to be able to display on the screen various menus (or OSD, standing for “On Screen Display”) intended to guide the user in his choice of the display options of the television set, and to allow the input of the commands of the system according to the invention. The images emanating from the video pipeline 110 and the menus emanating from the menu pipeline 115 can be brought together on one and the same video signal using an image compositor 120.

A color adaptor (interpolation matrix) 125 may be necessary at the output of the image compositor 120 depending of the coding format of the output signal. A digital/analog converter 130 may also be necessary depending on the type of television set, so as to deliver the analog output video signals (for example for a cathode ray tube).

A graphics corrector 140, for example a 2D graphics corrector, is also provided for improving the graphics applications.

The application programs are stored in a memory 150 for example a memory of flash type. A processor 135 is intended for the management of the circuit of FIG. 3.

Television interfaces 155 are provided for receiving or delivering other information originating from, or intended for peripheral equipment.

A time base generator 160 provides vertical V100 and horizontal H100 synchronization pulses intended for synchronization at the frequency 100 Hz of our example of the output signals (for example RGB signal), and which are deduced from the input synchronization signals HSYNC and VSYNC.

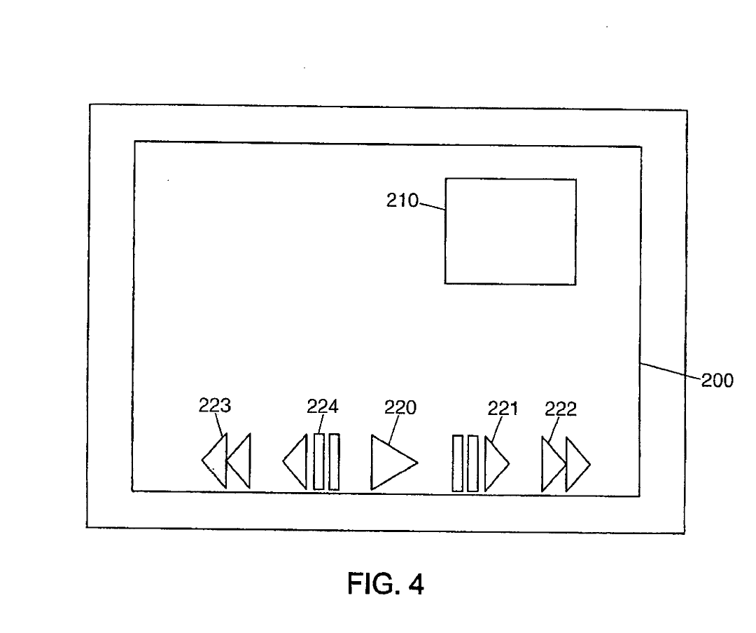

FIG. 4 represents an example of possible display on the basis of the sequence of images stored VIDEO_seq in the volatile memory. This sequence is represented in full-screen mode on the screen 200 of a television receiver. A window of reduced size 210 is represented in the upper right corner as an inset and allows the user to continue to follow the images of the program currently being broadcast.

A menu is available at the bottom of the screen 200 and forms part of the user interface. A read function 220, slow forward function 221, fast forward function 222, as well as slow rewind 224 or fast rewind 223 functions are accessible either by directly pressing the corresponding keys of a remote control box (not represented) of the user interface, or by moving a visible cursor on the screen, positioning it over symbols 220 to 224 corresponding to these functions. The corresponding functionality can be actuated by simple enabling via a key, provided for this purpose, of the remote control box.

Additional functionalities can also be envisaged such as freeze frame, frame-by-frame display, zooms from a selected zone of the image, etc. It is for example possible to achieve a so-called “multifreeze” mode that allows the user to choose the images which will constitute the sequence VIDEO_seq by actuation of a specific command on the user interface 50. The sequence is not then a sequence of consecutive images, or of images selected at regular time intervals (temporal decimation) but the result of a deliberate selection by the user.

The various types of television sets mentioned in this account are not limiting. The display system according to the invention can be applied to 50 Hz, 60 Hz, 75 Hz, 100 Hz or 120 Hz television sets, LCD or plasma type matrix panels or any other type of television sets that may be envisaged.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A system for displaying moving images, comprising:
an input for receiving a video signal transporting video images;
a user interface for receiving commands input by a user;
an input video subsystem for continuously generating a first stream of images on the basis of the input video signal;
at least one storage unit for storing a sequence of images extracted from the first stream of images, either continuously with a refresh mechanism until the receipt of a save command input by the user via the user interface, or in response to a record command input by the user via the user interface;
a module for vertical and/or horizontal decimation within the input subsystem that produces the images of the stored sequence of images by decimating the images of the first stream of images, the pixels of the decimated lines and/or columns of said images from said first stream of images not being stored in said storage unit; and
an output video subsystem for generating and displaying a second stream of images on the basis selectively of:
the first stream of video images,
the stored sequence of images, or
a combination of the two,
in response to an appropriate read command input by the user via the user interface.

2. The system according to claim 1, in which the output subsystem is devised so as, in response to respective commands input by the user via the command interface, to display the stored sequence of images according to an advanced mode of display, comprising forward or backward slow-motion display, forward or backward accelerated display, frame-by-frame display, freeze frame, and zoom.

3. The system according to claim 1, in which said module for vertical and/or horizontal decimation is further capable of temporal decimation, so as to produce the images of the sequence of images stored by temporally decimating the images of the first stream of images.

4. The system according to claim 3, in which the vertical and/or horizontal decimation factors of the decimation module can be selected by the user via the user interface.

5. The system according to claim 1, in which the storage unit comprises at least one SDRAM memory or one DDR memory.

6. The system according to claim 1, in which the output video subsystem comprises an upconversion device for the image flow, operating by interpolating images on the basis of the images of the first stream of images or of the sequence of stored images, the upconversion device being devised so as to access the storage unit in order to perform the interpolation of images.

7. The system according to claim 1, in which the system is included within a television.

8. A process for displaying moving images, comprising:
receiving a video signal transporting video images;
receiving commands input by a user on a user interface;
continuously generating a first stream of images on the basis of the input video signal;
storing a sequence of images extracted from the first stream of images, either continuously with a refresh mechanism until the receipt of a save command input by the user via the user interface, or in response to a record command input by the user via the user interface, said sequence of stored images being produced by vertical and/or horizontal decimation, the pixels of the decimated lines and/or columns of said images from said first stream of images not being stored; and
generating and displaying a second stream of images on the basis selectively of:
the first stream of video images,
the stored sequence of images, or
a combination of the two,
in response to an appropriate read command input by the user via the user interface.

9. The process according to claim 8, further comprising, in response to respective commands input by the user, displaying the stored sequence of images according to an enhanced mode of display, comprising forward or backward slow-motion display, forward or backward accelerated display, frame-by-frame display, freeze frame, and zoom.

10. The process according to claim 8, according to which the images of the sequence of stored images are also produced by temporally decimating the images of the first stream of images.

11. The process according to claim 10, according to which the vertical and/or horizontal and/or decimation factors of the decimation temporal can be selected by the user via the user interface.

12. The process according to claim 8, further comprising upconverting the image flow by interpolating images on the basis of the images of the first stream of images or of the sequence of stored images.

13. A system, comprising:
an input video subsystem operable to receive a first video signal corresponding to a program currently being viewed by a user, the input video subsystem outputting a second video signal based on the first video signal and further outputting a sequence of images taken from the first video signal;
a memory for storing the sequence of images;
an output video subsystem operable to receive the second video signal and access the memory to retrieve the sequence of images, the output video subsystem outputting a third video signal which combines the second video signal and the retrieved sequence of images for simultaneous viewing by the user.

14. The system of claim 13 wherein the second video signal and the retrieved sequence of images are simultaneously viewable in a mosaic format.

15. The system of claim 13 wherein the second video signal and the retrieved sequence of images are simultaneously viewable in a superimposed window format.

16. The system of claim 13 wherein the input video subsystem further outputs image frames necessary for an upconversion of the second video signal.

17. The system of claim 16 further including a memory for storing the image frames.

18. The system of claim 17 wherein the memory for storing the image frames and the memory for storing the sequence of images are the same memory.

19. The system of claim 17 wherein the output video subsystem is further operable to retrieve the image frames from memory and upconvert the second video signal in order to produce the third video signal.

20. The system of claim 13 further including a user interface through which the user inputs commands for selecting the sequence of images taken from the first video signal.

21. The system of claim 13, wherein the system is included in a television.

22. A method, comprising:
receiving a first video signal corresponding to a program currently being viewed by a user;
outputting a second video signal based on the first video signal;
outputting a sequence of images taken from the first video signal;
storing the sequence of images;
receiving the second video signal;
retrieving the stored sequence of images; and
outputting a third video signal which combines the second video signal and the retrieved sequence of images for simultaneous viewing by the user.

23. The method of claim 22 wherein the second video signal and the retrieved sequence of images are simultaneously viewable in a mosaic format.

24. The method of claim 22 wherein the second video signal and the retrieved sequence of images are simultaneously viewable in a superimposed window format.

25. The method of claim 22 wherein outputting the sequence of images further comprises outputting image frames necessary for an upconversion of the second video signal.

26. The method of claim 25 further including storing the image frames.

27. The method of claim 26 wherein storing the image frames and storing the sequence of images occur within the same memory.

28. The method of claim 25 further comprising retrieving the image frames from memory and upconverting the second video signal in order to produce the third video signal.

29. The method of claim 22 further user inputting of commands for selecting the sequence of images taken from the first video signal.

30. A system for displaying moving images, comprising:
an input for receiving a video signal transporting video images;
an input video subsystem for continuously generating a first stream of images on the basis of the input video signal;
a memory storing a sequence of images extracted from the first stream of images;
a decimation module within the input video subsystem operable to produce the sequence of images by decimating the first stream of images wherein pixels of the decimated first stream of images are not stored in the memory; and
an output video subsystem for generating and displaying a second stream of images which comprise a selected one of:
the first stream of video images,
the stored sequence of images, or
a combination of the first stream of video images and the stored sequence of images.

31. The system of claim 30 wherein the input video subsystem further outputs image frames necessary for an upconversion of the first stream of images.

32. The system of claim 31 further including a memory for storing the image frames.

33. The system of claim 32 wherein the memory for storing the image frames and the memory for storing the sequence of images are the same memory.

34. The system of claim 32 wherein the output video subsystem is further operable to retrieve the image frames from memory and upconvert the first stream of images in order to produce the second stream of images.

35. The system of claim 32, wherein the system is included within a television.

36. A process for displaying moving images, comprising:
receiving a video signal transporting video images;
continuously generating a first stream of images on the basis of the input video signal;
decimating first stream of images to produce a sequence of images;
storing the sequence of images, but not storing pixels of the decimated first stream of images; and
generating and displaying a second stream of images which comprise a selected one of:
the first stream of video images,
the stored sequence of images, or
a combination of the first stream of video images and the stored sequence of images.

37. The method of claim 36 wherein continuously generating further comprises outputting image frames necessary for an upconversion of the first stream of images.

38. The method of claim 37 further including storing the image frames.

39. The method of claim 38 wherein storing the image frames and storing the sequence of images occur in the same memory.

40. The system of claim 38 wherein generating and displaying further comprises retrieving the image frames from memory and upconverting the first stream of images in order to produce the second stream of images.

41. A television, including a system for displaying moving images on the television, the system comprising:
an input for receiving a television video image signal;
an input video subsystem for continuously generating a first stream of images on the basis of the input television video image signal;
a memory storing a sequence of images extracted from the first stream of images;
a decimation module within the input video subsystem operable to produce the sequence of images by decimating the first stream of images wherein pixels of the decimated first stream of images are not stored in the memory; and
an output video subsystem for generating for display by the television a second stream of images which comprise a selected one of:
the first stream of video images,
the stored sequence of images, or
a combination of the first stream of video images and the stored sequence of images.
